(19) United States
(12) Patent Application Publication
(10) Pub. No.: US 2015/0158188 A1
(43) Pub. Date: Jun. 11, 2015

(54) FORCE-BOOSTED SHEARS CAPABLE OF PULLING NAIL

(71) Applicant: CHIH-MIN CHANG, XIUSHUI TOWNSHIP (TW)

(72) Inventor: CHIH-MIN CHANG, XIUSHUI TOWNSHIP (TW)

(21) Appl. No.: 14/099,382

(22) Filed: Dec. 6, 2013

(51) Int. Cl. B26B 17/02

(52) U.S. Cl. CPC B26B 17/02

(57) ABSTRACT

Force-boosted shears capable of puling nails are formed of two handles, two cutting members, a connection unit, and a nail-pulling portion. Each of the handles includes a first pivotal portion and a second pivotal portion at one end thereof. The first pivotal portions are pivotably connected with each other. Each of the cutting members includes a first pivoting part, a second pivoting part, and a cutting portion. The first pivoting parts are pivotably connected to the connection unit. The second pivoting parts are pivotably connected to the second pivotal portions of the two handles, respectively. Each of the cutting portions includes a blade facing the other. The nail-pulling portion is located at at least one of the blades. In light of this, the force-boosted shears can shear things and pull nails.

### BACKGROUND OF THE INVENTION

1. Field of the Invention

The present invention relates generally to force-boosted shears and more particularly, to force-boosted shears capable of pulling nails.

2. Description of the Related Art

Conventional force-boosted shears are formed of two handles and two cutting members. Each of the two handles includes one end pivotably connected with one end of the other handle and pivotably connected with one end of one of the two cutting members. The two cutting members are pivotably mounted to a connection member and each include a plain blade. The two blades face each other.

A user can make the two handles pivot relatively away from each other for a larger pivoting angle to drive the two cutting members to pivot away from each other for a smaller pivoting angle, then put a target object between the two blades, and make the two handles pivot toward each other to drive the two blades to pivot toward each other to generate a great shearing force for shearing the target object.

U.S. Pat. No. 6,334,255, in addition to the aforesaid structure, force-boosted shears further include two blades mounted to the handles, respectively, and adjacent to where the two handles are pivotably interconnected, so such force-boosted shears can shear thin and thick target objects.

However, each of the two conventional force-boosted shears of the aforesaid two patents though has one single cutting portion or multiple cutting portions for shearing objects, but it does not have any other function.

### SUMMARY OF THE INVENTION

The primary objective of the present invention is to provide force-boosted shears which can shear objects and pull nails.

The foregoing objectives of the present invention are attained by the force-boosted shears formed of two handles, two cutting members, a connection unit, and a nail-pulling portion. Each of the handles includes a first pivotal portion and a second pivotal portion at one end thereof. The first pivotal portions of the two handles are pivotably connected with each other. Each of the cutting members includes a first pivoting part, a second pivoting part, and a cutting portion. Each of the second pivoting parts and each of the cutting portions are located at two sides of one of the first pivoting parts. The first pivoting parts of the cutting members are pivotably connected to the connection unit. The second pivoting parts of the cutting members are pivotably connected to the second pivotal portions of the two handles, respectively. Each of the cutting portions includes a blade facing the other. The nail-pulling portion is located at at least one of the blades.

### BRIEF DESCRIPTION OF THE DRAWINGS

FIG. 1 is a front view of a first preferred embodiment of the present invention.

FIG. 2 is a side view of the first preferred embodiment of the present invention.

FIG. 3 is a perspective view of the first preferred embodiment of the present invention.

FIG. 4 is a front view of a second preferred embodiment of the present invention.

FIG. 5 is a front view of a third preferred embodiment of the present invention.

FIG. 6 is a front view of a fourth preferred embodiment of the present invention.

FIG. 7 is a front view of a fifth preferred embodiment of the present invention.

### DETAILED DESCRIPTION OF PREFERRED EMBODIMENTS

Structural features and desired effects of the present invention will become more fully understood by reference to five preferred embodiments given hereunder. However, it is to be understood that these embodiments are given by way of illustration only, thus are not limitative of the claim scope of the present invention.

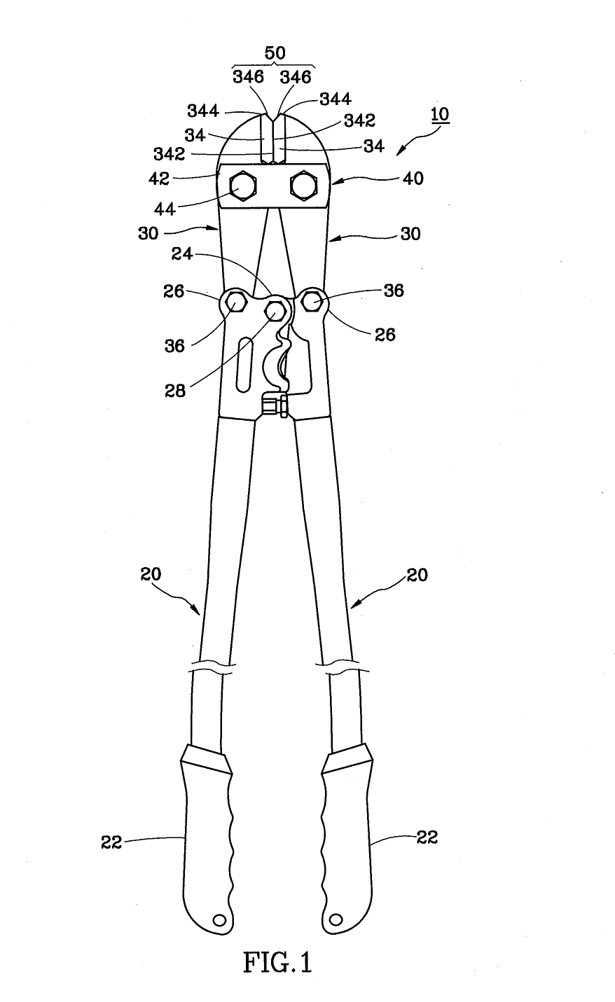

Referring to FIGS. 1-3, force-boosted shears 10 constructed according to a first preferred embodiment of the present invention is formed of two handles 20, two cutting members 30, and a connection unit 40. The detailed descriptions and operations of these elements as well as their interrelations are recited in the respective paragraphs as follows.

Each of the handles 20 is longer than either of the two cutting members 30 and includes a grip jacket 22 at one of two ends thereof for a user's handhold for operating the force-boosted shears 10. Each of the handles 20 includes a first pivotal portion 24 and a second pivotal portion 26 at the other end thereof. The two first pivotal portions 24 are pivotably connected with each other via a screw bolt 28; namely, the two handles are pivotable on the screw bolt 28.

Each of the cutting members 30 includes a first pivoting part 31, a second pivoting part 32, and a cutting portion 34. Each of the second pivoting parts 32 and each of the cutting portions 34 are located at two sides of one of the first pivoting portion 31. Each of the cutting portions 34 includes a blade 342 facing the other and a bevel edge 346 extending to the blade 342 from an end portion 344 thereof. Each of the second pivoting parts 32 is pivotably mounted to one of the second pivotal portions 26 via a screw bolt 36. In other words, the two cutting members 39 are pivotable relative to the two handles 20 on the two screw bolts 36.

The connection unit 40 includes two connection members 42 and two screw bolts 44. The first pivoting parts 31 are held and pivotably mounted between the two connection members 42 via the two screw bolts 44, respectively; namely, the two cutting members 30 are pivotable relative to the two connection members 42 on the two screw bolts 44.

When the user makes the two handles 20 pivot away from each other for a larger pivoting angle from a smaller pivoting angle shown in FIG. 1, the two blades 342 pivot away from each other to allow a target object (not shown) to be held between the two blades 342. In this way, when the user makes the two handles 20 pivot toward each other, the two blades 342 can generate a great shearing force to shear the target object.

In addition, when the force-boosted shears 10 are presented as shown in FIG. 1, i.e. the two blades 342 abut against each other, the bevel edges 346 jointly define a V-shaped nail-pulling portion 50. In this way, the force-boosted shears 10 can confine the nail within the nail-pulling portion 50 for pulling the nail, so the user can apply a force to the two handles 20 to remove the nail from a wood board or another object. In other words, the force-boosted shears 10 can not only shear things but pull the nail.

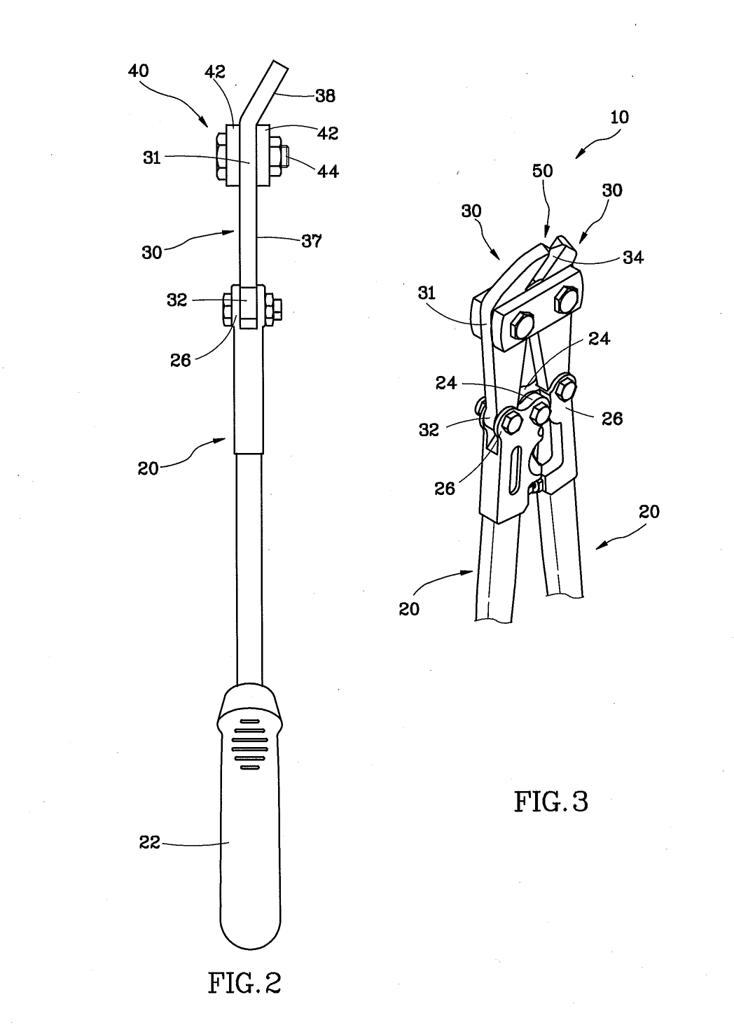

Referring to FIG. 2, each of the cutting members 30 can be bent to have a plain part 37 and an inclined part 38 sloping relative to the plain part 37. Each of the plain parts 37 is substantially plainly connected with one of the handles 20 and contains the first and second pivoting parts 31 and 32. The blades 342 are located at the inclined part 38, respectively. In this way, the nail-pulling portion 50 is located at the inclined parts 38 to make the force-boosted shears 10 more easily pull the nail.

It is worth mentioning that it is not limited for the nail-pulling portion 50 to be V-shaped and the nail-pulling portion 50 can be shaped like something mentioned in the following preferred embodiments as long as the nail-pulling portion 50 can hold the nail in situ and limit movement of the nail.

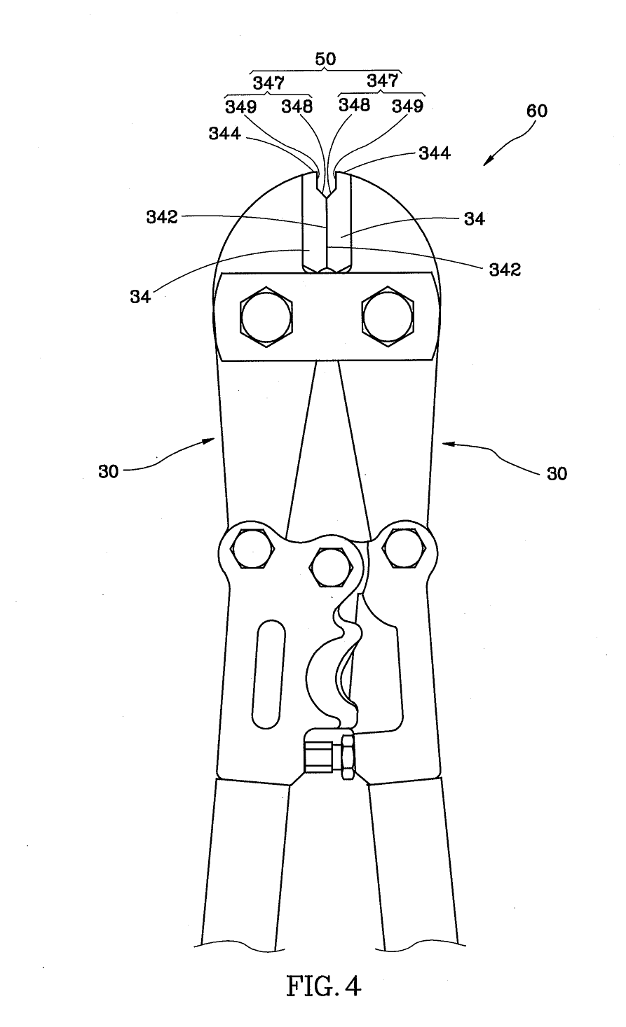

Referring to FIG. 4, in force-boosted shears 60 constructed according to a second preferred embodiment of the present invention, each of the cutting portions 34 of the cutting members 30 includes an open notch 347 formed at the end portion 344 and the blade 342. Each of the notches 347 is provided with a bevel edge 348 abutting against the blade 342 and an extended edge 349 extending to the end portion 344 from the bevel edge 348. The two notches 347 of the two cutting portions 34 jointly form the nail-pulling portion 50. In this way, when it is intended for the force-boosted shears 60 to pull the nail, the nail-pulling portion 50 can limit movement of the nail more effectively than that of the first preferred embodiment.

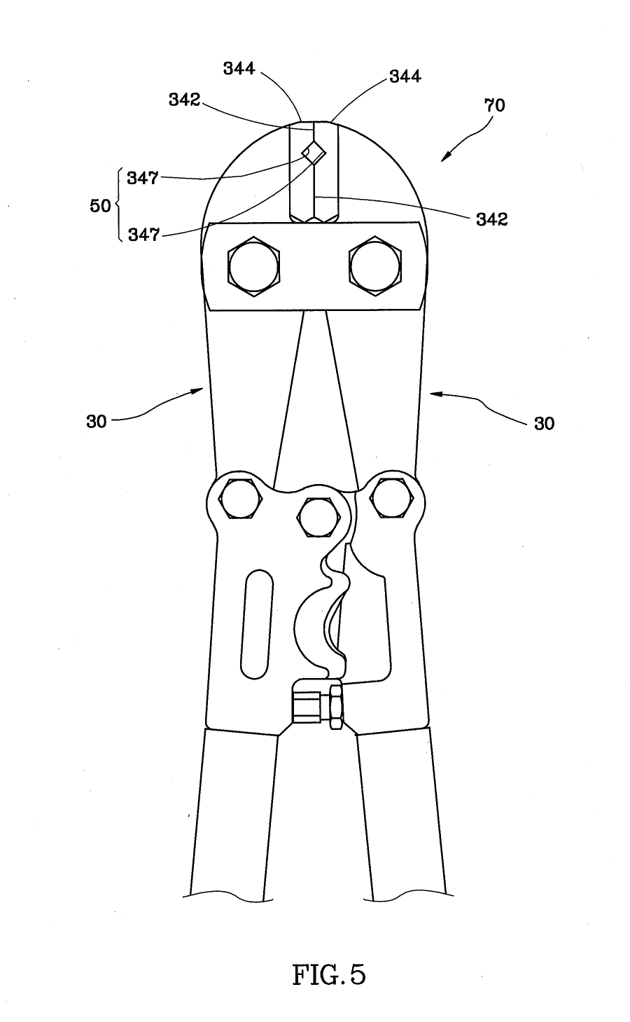

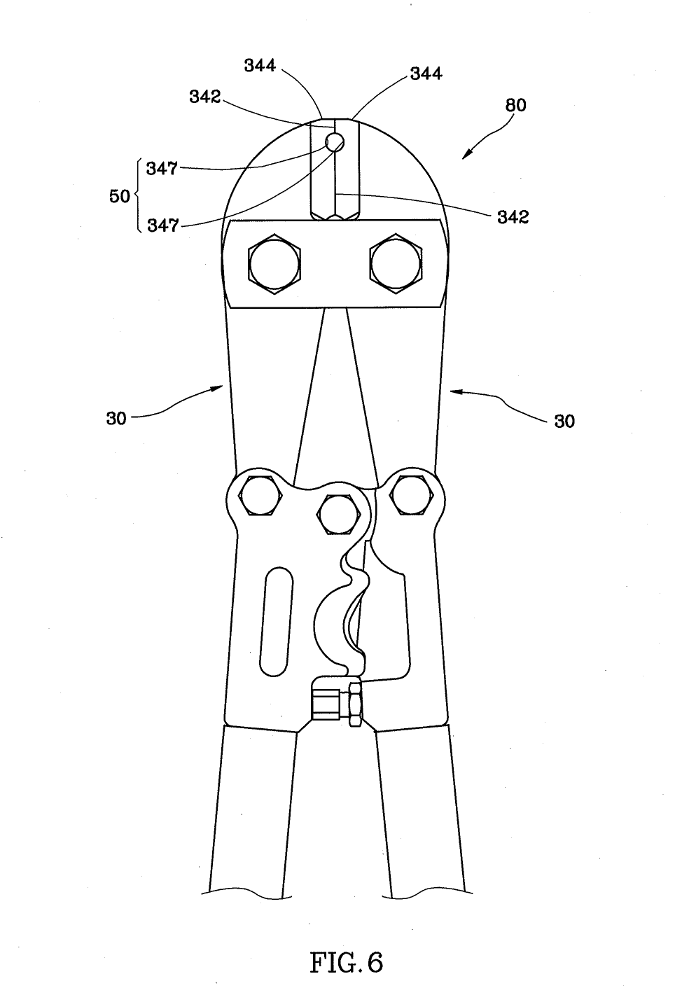

Referring to FIGS. 5 and 6, in each of force-boosted shears 70 constructed according to a third preferred embodiment of the present invention force-boosted shears 70 constructed according a fourth preferred embodiment of the present invention, the notch 347 of each cutting member 30 is open at the blade 342 but not open at the end portion 344 when the two blades 342 abut against each other. In this way, the nail-pulling portion 50 formed of the two notches 347 is closed to be quadrangular as shown in FIG. 5 and circular as shown in FIG. 6 and can limit movement of the nail more effectively than those of the aforesaid preferred embodiments.

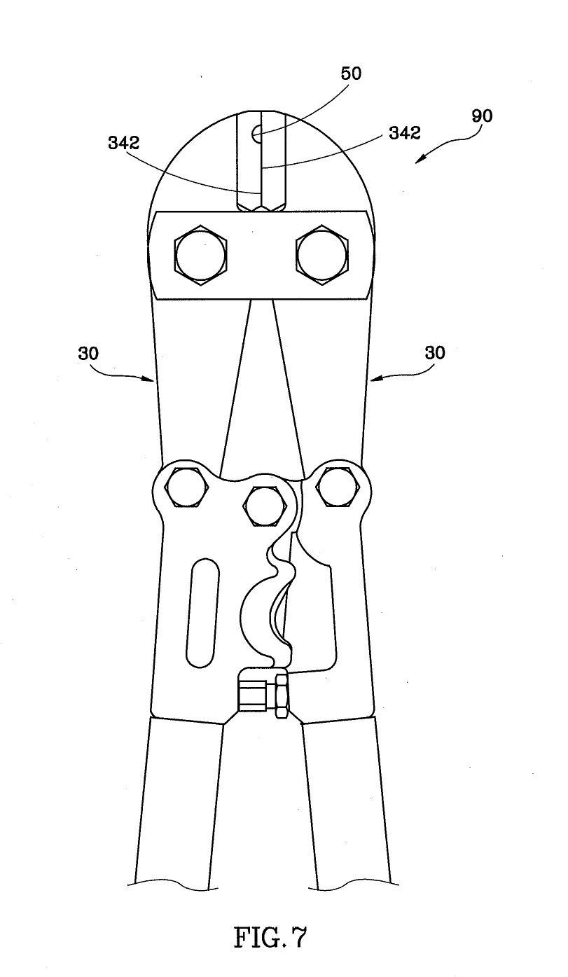

Referring to FIG. 7, in force-boosted shears 90 constructed according to a fifth preferred embodiment of the present invention, the nail-pulling portion 50 is located at one of the blades 342 only; namely, the other blade 342 does not have any notch. In this embodiment, the nail-pulling portion 50 is arc-shaped. Such structure is simpler than those of the aforesaid preferred embodiments and can limit movement of the nail likewise.

1. Force-boosted shears capable of pulling nails, comprising:
two handles, each of which has a first pivotal portion and a second pivotal portion at an end;
two cutting members, each of which has a fist pivoting part, a second pivoting part, and a cutting portion, the second pivoting part and the cutting portion being located at two sides of the first pivoting part, the two first pivoting parts being pivotably mounted to a connection unit, the two second pivoting parts being pivotably mounted to the second pivotal portions of the two handles, respectively, each of the cutting portions having a blade facing the other; and
a nail-pulling portion mounted to at least one of the blades.

2. The force-boosted shears as defined in claim 1, wherein each of the cutting portions comprises an end portion and a bevel edge extending to the blade from the end portion, the bevel edges of the cutting portions jointly forming the nail-pulling portion.

3. The force-boosted shears as defined in claim 1, wherein each of the cutting portions comprises an end portion and an open notch formed at the end portion and the blade, the two notches jointly forming the nail-pulling portion.

4. The force-boosted shears as defined in claim 3, wherein each of the notches of the cutting members comprises a bevel edge abutting against the blade and an extended edge extending to the end portion from the bevel edge.

5. The force-boosted shears as defined in claim 1, wherein each of the cutting portions comprises an open notch formed at one of the blades, the two notches jointly forming the nail-pulling portion.

6. The force-boosted shears as defined in claim 5, wherein the nail-pulling portion is quadrangular.

7. The force-boosted shears as defined in claim 5, wherein the nail-pulling portion is circular.

8. The force-boosted shears as defined in claim 1, wherein the nail-pulling portion is located at one of the blades.

9. The force-boosted shears as defined in claim 8, wherein the nail-pulling portion is arc-shaped.

10. The force-boosted shears as defined in claim 1, wherein each of the cutting members comprises a plain part substantially connected with one of the handles and an inclined part sloping relative to the plain part; the blades are located at the inclined parts, respectively.
